(19) United States
(12) Patent Application Publication
(10) Pub. No.: US 2003/0232219 A1
(43) Pub. Date: Dec. 18, 2003

(54) Magnetic disk, magnetic disk manufacturing method and magnetic disk apparatus

(76) Inventor: Hiroshi Nishizawa, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/458,183

(22) Filed: Jun. 11, 2003

(30) Foreign Application Priority Data
Jun. 13, 2002 (JP) 2002-172834
Jun. 21, 2002 (JP) 2002-181703
Jul. 1, 2002 (JP) 2002-192046
Aug. 5, 2002 (JP) 2002-227820

(51) Int. Cl. G11B 5/70

(52) U.S. Cl. 428/694 TS; 428/694 R; 428/694 TP

(57) ABSTRACT

Provided is a magnetic disk capable of reducing waves and realizing a high recording density. A main surface of the disk is made from a silicate glass substrate and has a magnetic recording layer and a shaft at its central portion. The sodium ions of the main surface of the disk are replaced with potassium ions so that the potassium ion concentration increases toward an outer circumference of the disk and the strength or rigidity of the disk increases accordingly toward the outer circumference of the disk. This can reduce waves which tend to occur on the outer circumferential side of the disk.

### BACKGROUND OF THE INVENTION

1) Field of the Invention

The present invention relates to a magnetic disk forming a recording medium and a method of manufacturing a magnetic disk, and further to a magnetic disk apparatus to be used as an external storage for a personal computer or the like.

2) Description of the Related Art

So far, as a magnetic disk forming a recording medium for a magnetic disk apparatus, there has been a disk formed into a doughnut-like configuration having a mounting hole at its central portion and made such that a required magnetic substance is formed on a non-magnetic substrate such as aluminum or glass. In addition, in a spindle motor for rotating the magnetic disk, there is mounted a hub made to be fitted in an inner-diameter portion of the disk, with the disk being fixed thereto to be rotatable through the use of a damper or the like. Data is recorded/reproduced on/from this disk by means of a magnetic head. Still additionally, the reduction of waves of the disk has been made for the purpose of achieving the reduction of the flying height of the magnetic head to meet the requirements for higher recording density to the magnetic disk apparatus. Yet additionally, as a non-magnetic substrate for disks, in view of the improvement of the rigidity of the disk which is required to cope with the size reduction of the magnetic disk apparatus, a glass has been employed more frequently than aluminum.

However, in the conventional magnetic disks, for enhancing the degree of disk's flatness, both surfaces thereof are usually polished with high accuracy by means of a surface grinding machine or the like. Moreover, although there is a need to reduce the thickness of the disk substrate itself in conjunction with the size and thickness reduction of the magnetic disk apparatus, difficulty is experienced in reducing the flying height of the head because the waves of the disk occur due to an decrease in its rigidity. Still moreover, since a high data transfer rate is preferable in the magnetic disk apparatus, there is a need to enhance the speed of rotation of the disk.

In addition, for the polish by the surface grinding machine or the like, the disk is required to have a flat-plate-like configuration, otherwise the machining becomes difficult. For this reason, the degree of freedom of the configuration is extremely low.

Furthermore, in the recent years, for further recording density increasing and accuracy improvement, a magnetic head has been shifted from an MR (Magnetoresistive) head to a GMR (Giant Magnetoresistive) head and further to a TMR (Tunnel Magnetoresistive) head. However, in fact, the electrification of a magnetic disk exerts influence unable to disregard on the performance of a magnetic head.

Still furthermore, so far, in a magnetic disk apparatus, there has been a need to increase the speed of rotation for higher data transfer rate. However, a combination of the increase in the speed of rotation and the employment of a high-sensitivity magnetic head creates a new problem in that the magnetic head is damaged stemming from the static electricity generated between the magnetic disk and air influenced due to the rotation of the magnetic disk. The enhancement of transfer rate and the reduction of the head flying height makes this problem more serious

### SUMMARY OF THE INVENTION

The present invention has been developed with a view to eliminating these inconsistent problems, and it is therefore an object of the present invention to provide a magnetic disk which produces less waves.

Another object of the present invention is to provide a magnetic disk manufacturing method capable of manufacturing an insignificant-wave magnetic disk at a low cost.

A further object of the present invention is to provide a magnetic disk apparatus equipped with an insignificant-wave magnetic disk and capable of achieving the higher-density recording and the thickness reduction.

A further object of the present invention is to provide a low-cost, less-wave, small-sized magnetic disk with higher reliability and to provide a manufacturing method therefor and a magnetic disk apparatus using the magnetic disk.

A further object of the present invention is to provide a magnetic disk capable of improving the accuracy at a low cost and further of reducing the static electricity electrification thereon.

For these purposes, in accordance with an aspect of the present invention, there is provided a magnetic disk with a glass substrate chemically reinforced so that its rigidity becomes higher toward an outer circumference thereof.

This can minimize the waves which occur in conjunction with the rotation of a magnetic disk.

According to another aspect of the present invention, there is provided a magnetic disk manufacturing method comprising a first step of melting a glass for a substrate of a magnetic disk, a second step of putting the melted glass in a mold with a required cavity to produce a disk substrate, and a third step of placing the disk substrate in a predetermined atmospheric condition to reinforce the disk substrate so that its rigidity further increases toward an outer circumference of the disk substrate.

With this method, it is possible to realize a magnetic disk reinforced so that its rigidity becomes higher toward its outer circumference and, hence, a machining process is omissible, which enables an decrease in the number of manufacturing steps to lead to the cost reduction. Moreover, the employment of the chemical treatment can prevent the occurrence of distortion.

According to a further aspect of the present invention, in the third step, the predetermined atmospheric condition is made such that the disk substrate is dipped in a potassium nitrate solution and is exposed to temperatures which becomes higher toward the outer circumference of the disk substrate to adjust reaction speed thereof.

According to a further aspect of the present invention, there is provided a magnetic disk manufacturing method comprising a step of melting a silicate glass containing sodium ions, a step of putting the melted glass in a mold for producing a disk glass substrate, and a step of placing the disk glass substrate, removed from the mold, in an atmospheric condition that a concentration of potassium ions increases successively toward an outer circumference of the disk glass substrate for replacing a portion of the sodium ions of the disk glass substrate with the potassium ions so that a rigidity of the disk glass substrate further increases toward an outer circumference of the disk substrate.

According to a further aspect of the present invention, there is provided a magnetic disk apparatus comprising a magnetic disk using a glass as a substrate, a motor for rotating the magnetic disk, a magnetic head for recording/reproducing data on/from the magnetic disk and a voice coil motor (VCM) for shifting the magnetic head to a given track, wherein the substrate is formed so that its rigidity increases toward its outer circumference.

This can minimize the waves which occur in conjunction with the rotation of a magnetic disk, thereby decreasing the head flying height to realize high-density recording. That is, in comparison with a disk with the same thickness, the quantity of waves of the disk according to the present invention is substantially equal thereto even if it undergoes rotation at a higher speed, which enables the reduction of the head flying height. In other words, this can reduce accordingly the thickness of the disk substrate for the equivalent recording density, which contributes greatly to the thickness reduction of the entire apparatus.

According to a further aspect of the present invention, there is provided a magnetic disk comprising a disk substrate made from a silicate glass, a magnetic recording layer provided on one main surface of the disk substrate, and rib means which is provided on the other main surface of the disk substrate and whose rigidity becomes higher as a position on the disk substrate approaches its outer circumference. This construction can reduce the waves occurring in connection with the rotation of the magnetic disk, and can lessen the flying height of a magnetic head, thereby realizing high-density recording.

In addition, in this construction, the width of the rib means becomes greater toward the outer circumference thereof. This additional construction can prevent the thickness of the entire disk from becoming great at an outer circumferential portion. Furthermore, the interferential or positional relation with respect to other parts at the rotation of the disk can be set equally irrespective of the position of the disk in radial directions, which facilitates the design distribution.

Still additionally, in the aforesaid disk construction, the rib means is made from a silicate glass, and a portion of sodium ions of the glass is replaced with potassium ions so that a concentration of the replacement potassium ions becomes higher toward the outer circumference thereof. This enables the rigidity of the rib means to be changed without changing the dimension of the rib means, which allows the optimization of the rigidity.

Moreover, in accordance with a further aspect of the present invention, there is provided a magnetic disk apparatus comprising a magnetic disk in which a silicate glass is used as a disk substrate and a magnetic recording layer is provided on one main surface of the disk substrate, a motor for rotating the magnetic disk, a magnetic head for carrying out the recording/reproduction on/from the magnetic disk, and a voice coil motor for moving the magnetic head to a required track, wherein, in the magnetic disk, a rib means whose rigidity becomes higher toward an outer circumference of the disk substrate is provided on the other main surface of the disk substrate. This construction can reduce the waves occurring in connection with the rotation of the magnetic disk, and can lessen the flying height of a magnetic head, thereby realizing high-density recording. That is, in comparison with a disk substrate with the same thickness, the value of waves of the disk according to the present invention is substantially equal thereto even if it undergoes rotation at a higher speed, which enables the reduction of the head flying height. In other words, this can reduce accordingly the thickness of the disk substrate for the equivalent recording density, which contributes greatly to the thickness reduction of the entire apparatus.

Still moreover, in the aforesaid magnetic disk apparatus construction, a shaft is formed integrally with the disk substrate at a central portion of the magnetic disk. With this structure, since the magnetic disk and a motor for rotating the magnetic disk share the shaft, the need for a damper is eliminable, which contributes to the thickness reduction and the cost reduction.

Furthermore, in accordance with a further aspect of the present invention, there is provided a magnetic disk using a silicate glass as a disk substrate wherein sodium ions contained in a surface portion of the disk substrate are replaced with potassium ions up to predetermined depths in the surface portion of the disk substrate so that a depth of the replacement of the sodium ions with the potassium ions from a surface of the disk substrate at an outer circumferential portion of the disk substrate is greater than a depth of the replacement of the sodium ions with the potassium ions therefrom at an inner circumferential portion thereof. This can reduce the waves occurring in conjunction with the rotation of the disk, and can decrease the head flying height to realize high-density recording.

According to a further aspect of the present invention, the replacement depth is set to be successively greater toward the outer circumferential portion of the disk substrate. This enables the rigidity of the disk substrate to increase successively toward the outer circumferential portion of the disk substrate, thereby reducing the head flying height to realize high-density recording.

According to a further aspect of the present invention, the disk comprises a shaft formed integrally with the disk substrate to be positioned at its central portion, with a magnetic recording layer being placed on a main surface of the disk substrate perpendicular to the shaft. Accordingly, the transfer of a magnetic pattern is feasible with reference to the shaft 2 and, as compared with a case in which it is done with reference to a disk hole, the stamping accuracy is improvable, which enables high-accuracy self-servo write.

According to a further aspect of the present invention, there is provided a magnetic disk manufacturing method comprising a step of melting a silicate glass containing sodium ions, a step of putting the melted glass in a cavity of a mold for producing a disk glass substrate, and a step of replacing a portion of the sodium ions of the silicate glass with potassium ions for chemically reinforcing the disk glass substrate, wherein a depth of the replacement from a surface of the disk glass substrate, which forms a replacement range in which the sodium ions are replaced with the potassium ions, is set to be successively greater toward an outer circumferential portion of the disk glass substrate. This method enables the formation of a disk substrate by means of molding, which permits the omission of a machining step, thereby reducing the number of manufacturing steps to contribute to the cost reduction. Moreover, since the outer circumferential portion of the disk undergoes the replacement of the sodium ions with the potassium ions more deeply, the rigidity of the outer circumferential portion of the disk becomes higher.

In addition, in accordance with a further aspect of the present invention, there is provided a magnetic disk apparatus comprising a magnetic disk using a glass for a disk substrate and having a shaft integrated with the disk substrate, a motor for rotating the magnetic disk, a magnetic head for carrying out the recording/reproduction on/from the magnetic disk, and a voice coil motor for moving the magnetic head to a required track, wherein, in the magnetic disk, sodium ions contained in a surface portion of the disk substrate are replaced with potassium ions up to predetermined depths in the surface portion of the disk substrate so that a depth of the replacement of the sodium ions with the potassium ions from a surface of the disk substrate at an outer circumferential portion of the disk substrate is greater than a depth of the replacement of the sodium ions with the potassium ions therefrom at an inner circumferential portion thereof to continuously enhance a rigidity of the disk substrate in a direction departing from the shaft.

With this construction, since the disk rigidity is continuously increased toward an outer circumferential portion of the disk, the waves occurring in connection with the rotation of the magnetic disk are reducible. This can reduce the flying height of the magnetic head, thereby realizing high-density recording. That is, in comparison with a disk substrate with the same thickness, the value of waves of the disk according to the present invention is substantially equal thereto even if it undergoes rotation at a higher speed, which achieves the reduction of the head flying height. In other words, this can reduce accordingly the thickness of the disk substrate for the equivalent recording density, which contributes greatly to the thickness reduction of the entire apparatus. Moreover, with this structure, since the magnetic disk and the spindle motor share the shaft, the need for a damper is eliminable, which contributes to the thickness reduction and the cost reduction.

Moreover, in accordance with a further aspect of the present invention, there is provided a magnetic disk comprising a flat member made of a glass forming a non-magnetic and electrical insulating material, a magnetic recording layer provided on one surface of the flat member, a shaft made of a glass forming a non-magnetic and electrically insulating material and formed integrally at a central portion of the flat member and on a surface of the flat member opposite to the magnetic recording layer provided surface thereof, and a protective film having an electrical conductive property and placed over the magnetic recording layer, the flat member and the shaft in the continuous form from the magnetic recording layer to the shaft.

This construction enables all dimensions of the disk to be prescribed with reference to the shaft and allows the electrification of the magnetic recording layer to be removed through the shaft. Thus, since there is no need to take into consideration the insurance of accuracy and the static electricity even if this disk is handled as well as a conventional magnetic disk, a drop of workability is preventable.

According to a further aspect of the present invention, an amorphous carbon material having an electrical conductive property is used as a principal component of the protective film. According to this aspect of the invention, the amorphous material can eliminate the anisotropy of the coefficient of thermal expansion and, hence, the magnetic material and the main surface axis do not undergo an anisotropic expansion/contraction stress due to temperature variations. Accordingly, this prevents the occurrence of various characteristic degradation such as the magnetic characteristic degradation of the magnetic film, the wave enhancement of the disk main surface and the decrease of the axial accuracy. Moreover, the electrification of a magnetic disk is easily removable and, because of the employment of a low-cost carbon material, a magnetic disk is realizable at a low cost.

Still moreover, in accordance with a further aspect of the present invention, there is provided a magnetic disk apparatus comprising a magnetic disk including a flat member made of a glass forming a non-magnetic and electrical insulating material, a magnetic recording layer provided on one surface of the flat member, a shaft made of a glass forming a non-magnetic and electrically insulating material and formed integrally at a central portion of the flat member and on a surface of the flat member opposite to the magnetic recording layer provided surface thereof, and a protective film having an electrical conductive property and placed over the magnetic recording layer, the flat member and the shaft in the continuous form from the magnetic recording layer to the shaft, a fluid bearing for rotatably supporting the shaft of the magnetic disk, a magnetic head disposed in the vicinity of the magnetic recording layer of the magnetic disk, and a circuit connected to the magnetic head for carrying out recording/reproduction of a signal on/from the magnetic disk, wherein a direct insulation resistance between the magnetic recording layer and the magnetic head is set to be higher than an indirect electric resistance developing through the circuit.

This can avoid the influence on the characteristics of the magnetic head, such as a degradation of sensitivity occurring because the static electricity electrification between the magnetic disk and air due to the rotation of the magnetic disk is discharged through a path having a low resistance value, thus realizing a magnetic disk apparatus with high reliability.

According to a further aspect of the present invention, in this magnetic disk apparatus, a magneto-resistive element is used as the magnetic head. Owing to the above-mentioned construction, a magneto-resistive element sensitive to static electricity becomes available. This enables high recording density without taking special measures against the static electricity, thereby achieving the size reduction at a low cost. Moreover, this enables the employment of a large-capacity magnetic disk for portable equipment or the like.

According to a further aspect of the present invention, in the above-mentioned magnetic disk apparatus, an oil having an electrical conductive property is used for the fluid dynamic bearing. This enables the static electricity to be discharged through the fluid dynamic bearing irrespective of a reduction of the flying height between the magnetic disk and the magnetic head, thus realizing a high-reliability magnetic disk apparatus without discharging the static electricity with respect to the magnetic disk.

According to a further aspect of the present invention, in the above-mentioned magnetic disk apparatus, when the magnetic disk apparatus is in a non-operating condition, the magnetic head is retreated into a position where its surface does not overlap with the disk in a face-to-face condition. This prevents the static electricity from being directly discharged from the magnetic disk to the magnetic head regardless of a condition of a circuit thereof when the magnetic disk apparatus is in a non-activated condition, which contributes to the improvement of reliability.

### BRIEF DESCRIPTION OF THE DRAWINGS

Other objects and features of the present invention will become more readily apparent from the following detailed description of the preferred embodiments taken in conjunction with the accompanying drawings in which:

FIG. 1 is a perspective view showing a magnetic disk (HDD) according to a first embodiment of the present invention;

FIG. 2 is an illustration of the relationship between a position on the disk in a radial direction and a potassium ion concentration according to the first embodiment of the present invention;

FIG. 3 is a flow chart useful for explaining a method of manufacturing the disk according to the first embodiment of the present invention;

FIG. 4 is a plan view showing an essential part of an HDD according to a second embodiment of the present invention;

FIG. 5 is a perspective view showing a magnetic disk according to a third embodiment of the present invention;

FIG. 6 is a perspective view of the magnetic disk of FIG. 5 when viewed from the opposite side;

FIG. 7 is a cross-sectional view of the magnetic disk, taken along a line X-X in FIG. 6;

FIG. 8 is an illustration of the relationship between a position on a magnetic disk in a radial direction and a potassium ion replacement depth according to a fifth embodiment of the present invention;

FIG. 9 is a flow chart showing a method of manufacturing a magnetic disk according to the fifth embodiment of the present invention;

FIG. 10 is a cross-sectional view showing a magnetic disk according to a seventh embodiment of the present invention;

FIG. 11 is an exploded perspective view showing the relation between a magnetic disk and a bearing according to the seventh embodiment of the present invention; and

FIG. 12 is a characteristic illustration of a ratio in resistance between a magnetic disk and a magnetic head in a magnetic disk apparatus and a sensitivity variation of the head.

### DESCRIPTION OF THE PREFERRED EMBODIMENTS

Embodiments of the present invention will be described hereinbelow with reference to the drawings.

(First Embodiment)

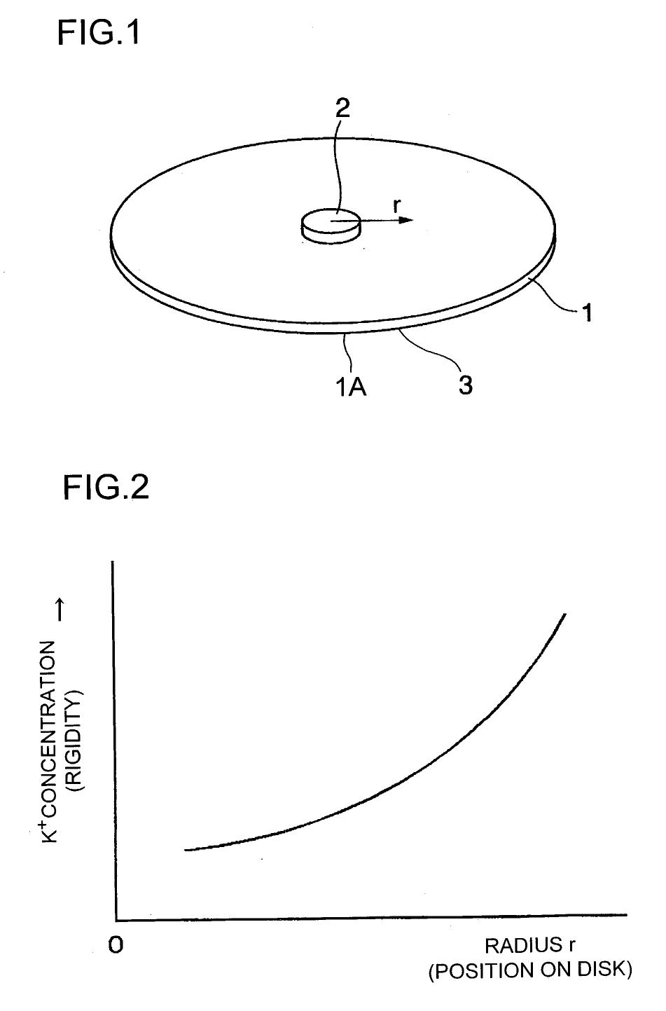

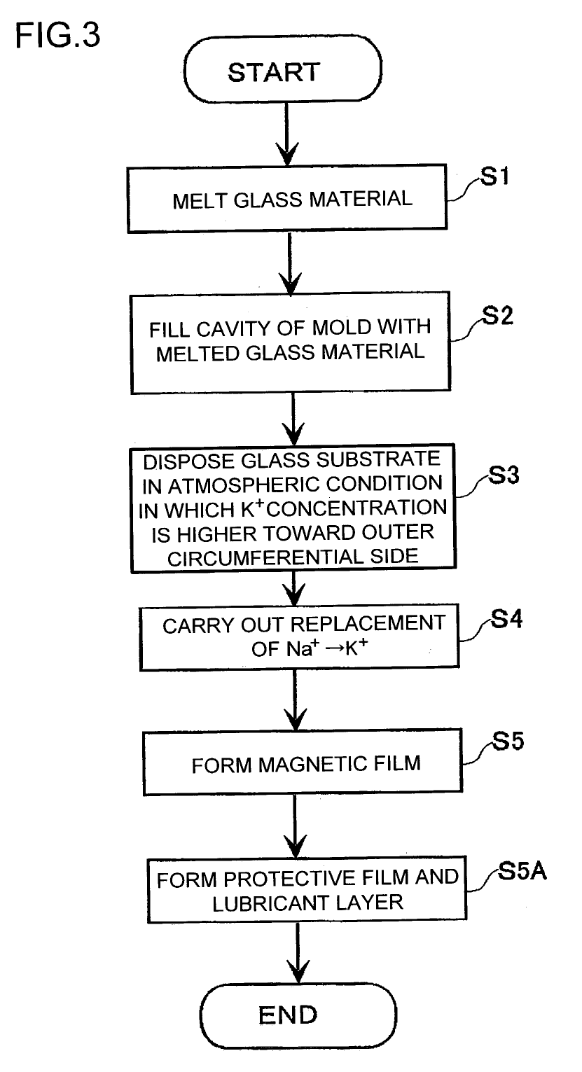

FIG. 1 is a perspective view showing a magnetic disk according to a first embodiment of the present invention, FIG. 2 is an illustration of the relationship between a position in a radial direction of the disk and a potassium ion concentration according to the first embodiment of the present invention, and FIG. 3 is a flow chart useful for explaining a method of manufacturing the disk according to the first embodiment of the present invention.

First of all, referring to FIG. 1, a description will be given hereinbelow of a structure of a magnetic disk (which will hereinafter be referred to equally as a “disk”).

In FIG. 1, the disk (disk substrate 1), having a main surface 1A, is composed of a silicate glass substrate having a diameter of approximately 20 mm (0.8 inch) and a thickness of approximately 0.3 mm, and a shaft 2 made of the same material is provided at a central portion thereof, with the shaft 2 being formed to have a diameter of approximately 4 mm and a length of 0.8 mm. On the main surface 1A, there is additionally formed a magnetic recording layer 3 made such that a magnetic material such as Co—Cr-based material is build up by means of sputtering for magnetic recording and a protective film is formed thereon through the use of DLC (Diamond Like Carbon) or the like and a lubricant material using a fluorine-based material or the like as a main component is further formed thereon. The structure of the magnetic recording layer 3 depends properly upon the surface recording density of a disk to be used or the head flying height. In this embodiment, the flying height is set at approximately 15 to 25 nm, and the surface recording density is set at 30 Gbpsi (Giga Bits Per Square Inch). Moreover, the shaft 2 is added so that the center of gravity of the entire disk shifts to the shaft 2 portion.

As glass reinforcing method, there have well known a method of quenching a glass to apply a stress physically thereto or a method of treating it chemically. In this embodiment, a chemical reinforcement is employed in order to avoid the occurrence of substrate distortion.

Concretely, sodium ions of a silicate glass are replaced with potassium ions each having a radius larger than that of the sodium ions and belonging to the same IA group in the periodic table at a portion of a depth of 20 to 80 μm from the surface.

In this embodiment, the chemical reinforcement of the disk utilizes the fact that the radius of an sodium ion is approximately 0.1 nm while the radius of a potassium ion is approximately 0.13 nm larger than that of the sodium ion. This difference in radius therebetween produces a compressive stress on a surface of the glass, thereby enhancing the strength of the glass.

In this way, as shown in FIG. 2, the potassium ion concentration becomes higher as the position on the disk approaches an outer circumference of the disk in radial directions. With this structure, the strength of the glass becomes higher toward an outer circumference of the disk. That is, the rigidity thereof becomes higher as the position on the disk approaches the outer circumference thereof. This enables the reduction of waves of the disk which tend to occur at the outer circumferential side of the disk.

Thus, the waves incidental to the rotation of the disk are reducible. Accordingly, on the recording density or flying height condition permitting equivalent waves, the thickness reduction of the glass substrate becomes feasible. That is, the weight reduction and the thickness reduction are achievable. Moreover, in other words, if the disks have the same thickness, a further reduction of the flying height becomes feasible and a further reduction of the space loss becomes possible, which signifies that the recording density is improvable.

Secondly, a description will be given hereinbelow of the construction in which the shaft 2 is integrated with the disk.

This shaft 2 can be formed integrally with the disk substrate 1 using a glass, or it also can be formed separately before being integrated therewith. For the shaft 2, every material is properly employable, provided that its coefficient of linear expansion is similar to that of a glass.

Usually, a conventional disk, having a doughnut-like configuration, is fitted in a cylindrical member, called a hub, set on a spindle motor to be engaged with an inner-diameter portion of the disk, and is fixed through the use of a ring, called a clamper, or the like. However, As the recording density increases, the track pitch also comes into a high-density condition. Therefore, for the recording of a servo signal for detecting a position of a track, the servo signal is self-servo-written. In details, as disclosed in Japanese Patent Laid-Open No. 2001-243733, a servo pattern for a track to be used actually is written with respect to a master pattern made by magnetic transfer or the like. In this manner, the RRO (Repeatable Run-Out) occurs due to the alignment error between a hub and the inner-diameter portion of a disk when the disk is mounted in the apparatus, the run-out of the shaft of a spindle motor, the phase shift thereof, or the like. On the other hand, according to the present invention, the shaft 2 integrated with the disk functions as the shaft itself of the spindle motor and, hence, the occurrence of the RRO is reducible, which enables a servo pattern to be easily and satisfactorily written even in the case of a higher-track density. Moreover, this can eliminate the need for the use of a clamper, which achieves the cost reduction and the thickness/weight reduction of the HDD. Still moreover, the main surface can be machined into a degree of flatness with reference to the shaft 2 and the plane machining becomes feasible in view of a portion of run-out components and, hence, high-accuracy machining becomes possible because it is done under a condition close to the actually using condition, thus allowing the improvement of the recording density.

Furthermore, referring to a flow chart of FIG. 3, a description will be given hereinbelow of a method of manufacturing a disk according to the first embodiment of the present invention. For carrying out the procedure shown in FIG. 3, a glass material, which has previously undergone preparation/adjustment treatment, is placed into a cullet condition.

First, the glass material is melted (step S1). The heating temperature therefor is properly set at a temperature (viscosity) higher than the softening point, taking viscosity into consideration. Preferably, the condition thereof is determined taking into consideration the molding time, molding characteristics, the capability of the molding machine, and other factors.

Following this, for molding, the melted glass material is put in a mold with a cavity having a required configuration (step S2). Preferably, as the material (SiC, ZrO₂, or the like) of the mold, and for the surface treatment, the coating and others, appropriate materials (TiC, TiN, or the like) are used taking the glass used into consideration. In this embodiment, the shaft 2 is molded at the same time.

Subsequently, the molded body is gradually cooled and is taken out from the mold. The disk substrate removed therefrom undergoes chemical reinforcement. That is, sodium ions of the disk substrate are replaced so that potassium ions exist at higher concentrations as the position on the disk substrate becomes closer to an outer circumferential side of the disk substrate (steps S3 and S4). Concretely, the disk substrate is immersed in a potassium nitrate solution, and is exposed to temperatures which become higher toward the outer circumference of the disk substrate so that the reaction speed thereof becomes higher. The molar concentration and others are set taking the temperature, the time and others into consideration. Another method is also acceptable, provided that the replacement (or substitution) is made so that the outer circumferential side has a higher potassium ion concentration.

Thereafter, the cleaning treatment and others are carried out with respect to the glass substrate, and a Co—Cr-based magnetic thin film is formed thereon by means of the sputtering technique (step S5), and a DLC serving as a protective film and a lubricant layer are further formed thereon (step S5A). The film formation is conducted by appropriately selecting the degree of vacuum, the Ar gas density, the condition on the target, the under-layer or seed layer for the formation of the magnetic layer, and others, thereby providing a disk with satisfactory magnetic characteristics.

In addition, since the disk manufacturing method according to this embodiment realizes the formation of a magnetic disk substrate reinforced so that its rigidity increases as the position approaches its outer circumference in such a manner as to conduct a step of melting a silicate glass containing sodium ions, a step of putting the melted glass in a mold for producing a disk glass substrate, and a step of replacing a portion of sodium ions with potassium ions, that is, placing the disk glass substrate, removed from the mold, in such an atmospheric condition that a concentration of potassium ions for replacement increases toward an outer circumference of the disk glass substrate, a machining step is omissible, which decreases the number of manufacturing steps and reduces the manufacturing cost. Still additionally, because of the employment of the chemical treatment, the occurrence of distortion is preventable.

(Second Embodiment)

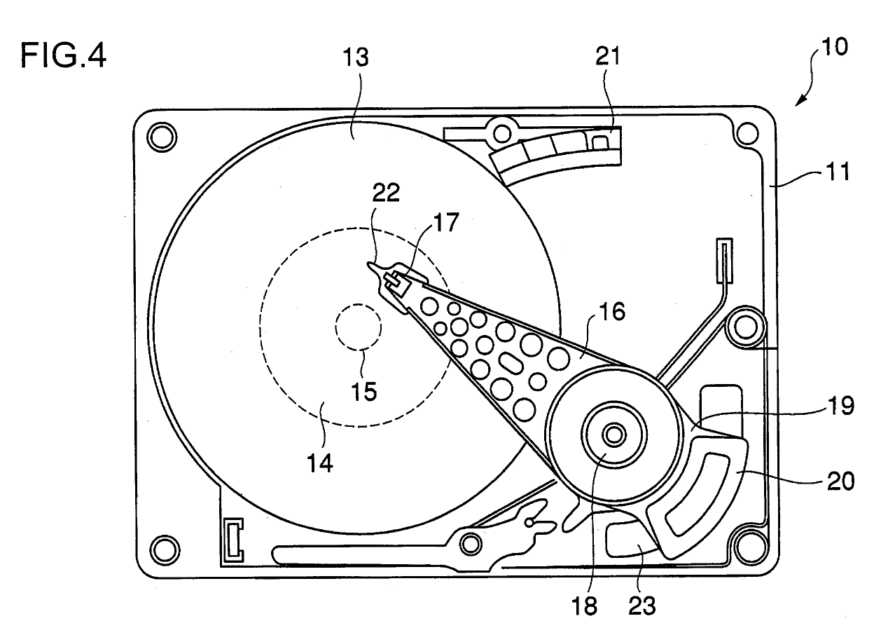

Furthermore, referring to FIG. 4, a description will be given hereinbelow of a magnetic disk apparatus according to a second embodiment of the present invention. FIG. 4 is a plan view showing an essential part of a magnetic disk apparatus (which will hereinafter be referred to simply as an “HDD”) according to the second embodiment of the present invention. In FIG. 4, an HDD except a circuit section will be referred to hereinafter as an “HDA (Head Disk Assemble).

The HDA, generally designated at reference numeral 10, is equipped with an aluminum-made chassis 11 having a generally rectangular-box-like configuration and a cover (not shown) for covering the chassis 11. In addition, in the interior of the HDA 10, there is disposed a disk 13 forming a magnetic recording medium produced such that a Co—Cr-based magnetic terminal is built up on a non-magnetic substrate, made of a glass, by means of sputtering and a required substrate, protective film and lubricant material are formed thereon. In this embodiment, the diameter of the disk 13 is as small as approximately 20 mm (0.8 inch). A spindle motor 14 is provided therein to rotate the disk 13 at a constant speed. A fluid dynamic bearing, having a herringbone type groove, is used as a bearing 15 of the spindle motor 14, and the spindle motor 14 is of a circumference opposed DD type. The shaft 2 set on the disk 13 is directly used as a shaft of the spindle motor 14. Moreover, since the center of gravity of the disk 13 is designed to lie at the shaft 2 portion as mentioned above, the spindle motor 14 can rotate the disk 13 with high rotational accuracy, thus securely satisfying the radial run-out prescribed for the RRO, NRRO (Non Repeatable Run-Out) and others.

A magnetic head 17 to be used for the recording/reproduction on/from the disk 13 is mounted on a gimbal spring (not shown) at a tip portion of a suspension 16 for supporting the magnetic head 17, and a biasing force is transmitted through a load beam (not shown). In the magnetic head 17, a write thin-film head and a readout GMR (Giant Magneto Resistance) head are mounted on a slider (not shown). The slider is of a negative pressure type having an ABS (Air Bearing Surface) formed into a required configuration.

The suspension 16 is supported by a pivot bearing 18 to be rotatable in tracking directions (radial directions) of the disk 13. An actuator is made up of the suspension 16 and a coil arm 19. The actuator is rotated and positioned by a voice coil to shift the magnetic head 17 in a given track direction, or to position it. On the outer circumferential side of the disk 13, a ramp (retreating member) 21 is placed at a retreating position of the actuator, and in cooperation with a tab 22 set at the tip portion of the suspension 16, it unloads the actuator at the retreating position when the HDD falls into an operation-suspended condition, and holds the actuator at the retreating position while the HDD is in a non-operated condition.

Onto a lower surface of the chassis 11, there are fixedly secured a circuit substrate on which packaged are a drive circuit for controlling operations of motors and others, an R/W (Read/Write) circuit, an HDC (Hard Disk Controller), and other components, thus constituting an HDD. This HDD is provided with a load/unload mechanism. On a surface of the disk 13, there are tracks concentrically disposed to hold the recorded data and servo information. The servo information is self-servo-written after the magnetic transfer as mentioned above. Each of the tracks is finely divided into sectors in units of 512 bytes or the like. The zone bit recording is carried out so that the track recording density becomes substantially constant at track positions. In this embodiment, the division is made into eight zones.

In this embodiment, the HDA is referred to as 1-platter 1-head, and only the upper surface of the disk 13 is employed as a recording surface and one magnetic head 17 is put to use. The magnetic head 17 records data through a circuit substrate (not shown) on the disk 13, or reads out recorded data from the disk 13. For the recording, the code conversion is made in units of bytes through the use of the 16-17 modulation mode (16-bit data is converted into 17-bit data and recorded), thus realizing the enhancement of the storage capacity and the improvement of the recording/reproduction characteristics. These signals are interchanged through an FPC (Flexible Printed Circuit), connected to a head amplifier, or the like with respect to the magnetic head 17.

The magnetic head 17 is biased toward the disk 13 by a biasing force given from the suspension 16, and owing to the occurrence of given positive/negative pressures stemming from the ABS surface of the slider and an air flow occurring due to the rotation of the disk 13, the magnetic head 17 is made to float stably by a very slight flying height.

The voice coil motor is made up of a coil 20, upper and lower yokes (not shown), a magnet 23 and others. The magnet 23 is disposed through a predetermined gap in opposed relation to a lower end surface of the coil 20 fixedly secured to the coil arm 19 of the actuator. This construction establishes a magnetic circuit, and the coil arm 19 is placed in a space sandwiched between the upper yoke and the magnet 23 so that the coil 20 is rotatable. The magnet 23 is of an Nd—Fe-based sintered type having a high energy product, with its surface being rustproofed with Ni and the magnetization being made to produce two poles in one plane.

Although not shown, the ramp 21 has a composite plane comprising oblique and flat surfaces corresponding to the tab 22 and others, with the composite plane being disposed in a moving direction of the tab 22 related to a rocking action of the suspension 16 at the time of the unloading, that is, in a state directed at the outer side of the disk 13 in its radial direction, and fixedly secured to the chassis 11. The actuator, the voice coil motor and the ramp 21 constitute a load/unload mechanism.

A description will be given hereinbelow of an operation of the HDD. The spindle motor 14 is driven through the circuit substrate so that the disk 13 is rotated at a predetermined rotational speed. In this embodiment, the rotational speed is set at 50S⁻¹ (3,000 rpm). The magnetic head 17 retreated at the ramp 21 is rotationally driven around the pivot shaft 18 by the voice coil motor to load the magnetic head 17 on a surface of the disk 13. Due to an air flow stemming from the rotation of the disk 13, the biasing force of the suspension 16 and the effect of the ABS of the slider, the magnetic head 17 floats stably by a very slight flying height (approximately 15 to 25 nm) with respect to the disk 13. In this state, the loading of the magnetic head 17 reaches completion. Subsequently, track information is read out thereby, then followed by the implementation of a series of operations such as track recognition, called acquire. When the coil 20 is energized, the voice coil motor generates a trust due to a magnetic flux from the magnet 23 and a current flowing through the coil 20. Because the magnet 23 is in a fixed state, the coil 20 generates the torque as a reaction to revolve the actuator around the pivot shaft 18. Thus, the actuator is rotated by an angle corresponding to an energizing quantity of the coil 20. The magnetic head 17 supported by the suspension 16 is shifted in a floating state over the disk 13 in a radial direction of the disk 13, and is positioned with respect to a desired track to carry out the recording/reproduction on/from the disk 13.

In the HDD according to this embodiment, since the rigidity of the disk 13 is made to increase as the position on the disk 13 separates from the spindle shaft, the waves at the outer circumferential side of the disk 13 during the rotation are reducible, which leads to the floating taking a stable flying height. For the enhancement of the rigidity, potassium ions are substituted for sodium ions as mentioned above. Moreover, since the disk 13 and the spindle motor 14 share the shaft 2, the need for a damper is eliminable, which contributes to the thickness reduction and the cost reduction. A test indicated that, when the speed of rotation was increased up to 4,000 rpm, less waves occurred and a desirable result was produced. This result shows that further reduction in thickness of the disk substrate is feasible. Therefore, according to this embodiment, the thickness and weight reductions of the HDD and the density enhancement are achievable irrespective of the cost reduction.

In addition, in the disk 13 according to this embodiment, since the shaft 2 is formed integrally at a central portion of the disk 13 and the magnetic recording layer 3 is formed on the main surface 1A perpendicular thereto, the transfer of a magnetic pattern is feasible with reference to the shaft 2. As compared with a case in which it is done with reference to a disk hole, the transfer accuracy is improvable, which enables high-accuracy self-servo write.

(Third Embodiment)

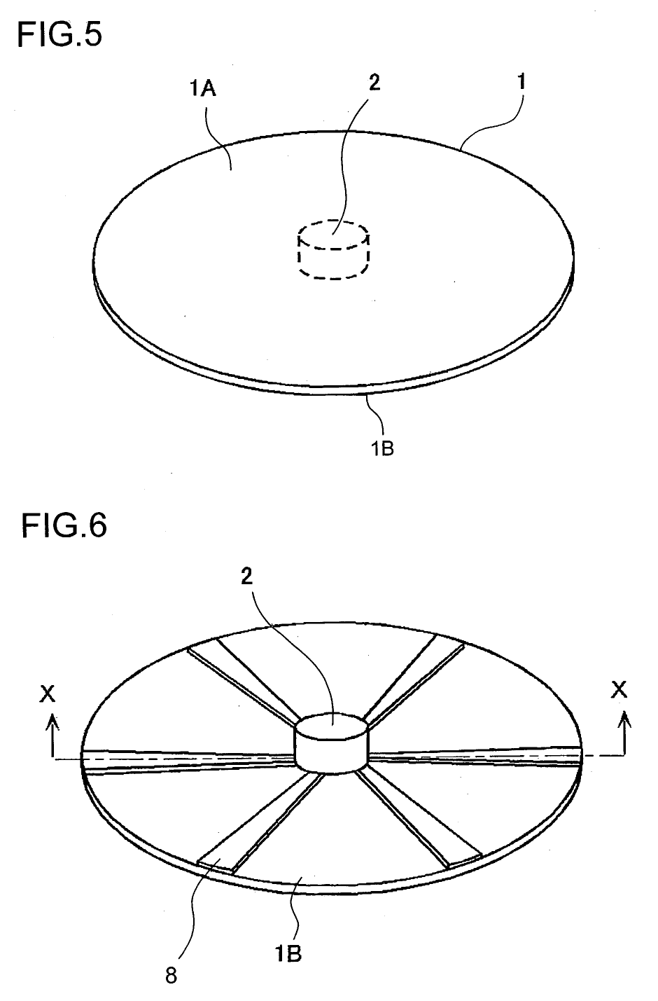

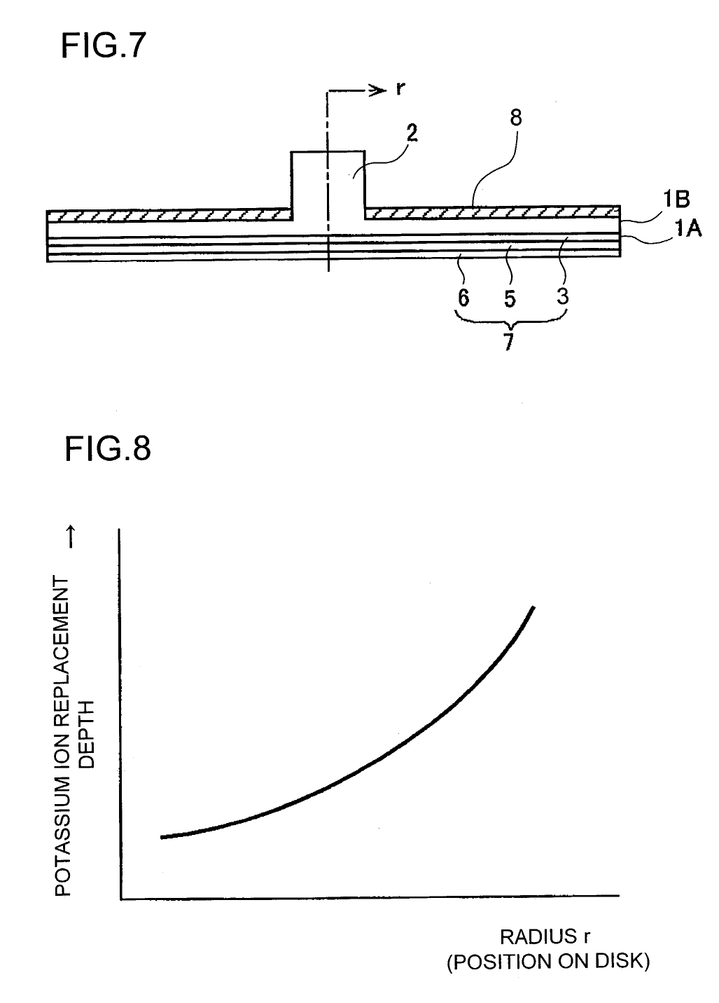

Referring to FIGS. 5 to 7, a description will be given hereinbelow of a magnetic disk according to a third embodiment of the present invention. FIG. 5 is a perspective view showing a magnetic disk according to the third embodiment of the present invention, FIG. 6 is a perspective view of the magnetic disk of FIG. 5 when viewed from the opposite side, and FIG. 7 is a cross-sectional view of the magnetic disk, taken along a line X-X in FIG. 6.

First, the description thereof will start at a structure of the magnetic disk according to the third embodiment.

In FIG. 5, as well as the above-described first embodiment, the magnetic disk (disk substrate 1), having main surfaces 1A and 1B, is composed of a silicate glass substrate having a diameter of approximately 20 mm (0.8 inch) and a thickness of approximately 0.3 mm, and a shaft 2 (see the first embodiment of the invention) made of the same material is provided at a central portion thereof, with the shaft 2 being formed to have a diameter of approximately 4 mm and a length of 0.8 mm. Of the main surfaces 1A and 1B, one surface 1A is made to be a flat surface having no irregularities. A magnetic layer (magnetic recording layer) 3, such as Co—Cr-based material, is build up thereon by means of sputtering for magnetic recording and a protective film 5 is then formed thereon through the use of the DLC or the like and a lubricant layer 6 using a fluorine-based material or the like as a main component is further formed thereon.

The magnetic recording layer structure, designated at reference numeral 7, comprising the magnetic layer 3, the protective film 5 and the lubricant layer 6 depends properly upon the surface recording density of a disk to be used or the head flying height. In this embodiment, the flying height is set at approximately 15 to 25 nm, and the magnetic layer 3, the protective film 5 and the lubricant layer 6 are set at approximately 13 nm, 5 nm and 2 nm in thickness, respectively. Moreover, the surface recording density is set at 30 Gbpsi. The substrate of the magnetic disk is integrally formed in a manner such that a glass material, which has previously undergone preparation/adjustment treatment, is placed into a cullet state and placed into a condition to allow the molding at a temperature higher than the softening point after headed and melted and, together with the shaft 2, is put in a mold and pressurized.

As FIG. 6 shows, ribs 8 extending in radial directions are provided on the main surface 1B existing on a side opposite to the main surface 1A holding the magnetic recording layer 7. Each of the ribs 8, made of a glass, is fabricated integrally together with the disk substrate 1. In FIG. 6, the ribs 8 are six in number and each extends from the vicinity of the shaft 2 to an outer circumferential end surface, and the six ribs are arranged at a substantially equal interval. However, it is also possible to properly and selectively determine the number of ribs 8, the interval therebetween, the position in the vicinity of the shaft 2, and others. In this embodiment, the height of the ribs 8 is made constant to be 0.08 mm, while the width thereof is in a range of 0.2 mm to 1.4 mm. Each of the ribs 8 is made such that its rigidity increases successively or continuously toward an outer circumference of the disk. Moreover, preferably, each of the ribs 8 is formed into a trapezoidal configuration in cross section. In particular, it is preferable that a draft angle is sufficiently secured taking the separation from the mold into consideration.

The material (SiC, ZrO₂, or the like) of the mold, the surface treatment, the coating and others can properly be selected taking into consideration the material of the glass to be used, the molding temperature and the life, and other factors.

Since, as mentioned above, the ribs 8 extending radially are provided on the main surface 1B on the opposite side to the main surface 1A carrying the magnetic recording layer 7, waves are reducible which tend to occur because the rigidity lowers at the outer circumferential side when the magnetic disk is in rotation. Thus, under the condition on the recording density or flying height which permits a given degree of waves, the thickness of the glass substrate is reducible accordingly. That is, the weight reduction and the thickness reduction become realizable. In other words, if the disk thickness is the same, the further reduction of the flying height becomes feasible and the further reduction of the space loss becomes possible, which contributes to the improvement of the recording density. In general, it is known that the rigidity of a flat-plate-like disk is in inverse proportion to the square of the radius. The rigidity of the disk may be set to be made constant taking into consideration an effect of the height of the ribs 8 and an effect of the width thereof. In fact, it is preferable that the rigidity thereof is optimized while measuring the waves of the magnetic disk (that is, main surfaces).

Referring again to FIG. 2 showing the relationship between the replacement potassium ion concentration and a position on the magnetic disk in its radial direction, a description will be given hereinbelow of the reinforcement of the ribs 8 in radial directions. As seen from FIG. 2, in the ribs 8, the replacement potassium ion concentration indicated by the vertical axis is made to become higher as the position on the disk indicated by the horizontal axis approaches the outer circumference thereof. Accordingly, the glass strength increases successively toward the outer circumference of the disk. That is, this enhances the rigidity of the disk as the position thereon becomes closer to the outer circumference thereof.

In this embodiment, the sodium ions of the silicate glass substrate are replaced with potassium ions each having a radius larger than that of the sodium ions and belonging to the same IA group in the periodic table with respect to a portion at a depth of several tens to 100 μm from the surface.

As well as the above-described first embodiment, also in this embodiment, the chemical reinforcement of the disk (ribs 8) utilizes the fact that the radius of an sodium ion is approximately 0.1 nm while the radius of a potassium ion is approximately 0.13 nm larger than that of the sodium ion. This difference in radius therebetween produces a compressive stress on a surface of the glass, thereby enhancing the strength of the glass. Concretely, the disk substrate 1 (ribs 8) is immersed in a potassium nitrate solution, and is pressurized to promote the reaction speed toward the outer circumference of the disk or exposed to temperatures which become higher toward the outer circumference thereof. The molar concentration and others are set taking the temperature, the time and others into consideration. Another method is also acceptable, provided that the replacement is made so that the outer circumferential side has a higher potassium ion concentration. According to this manner, after the molding by a mold, the variation gradient of the rigidity in radial directions can be adjusted on the basis of the replacement potassium ion concentration, which enables the optimization of the rigidity.

(Fourth Embodiment)

A description will be given hereinbelow of a magnetic disk apparatus (HDD) according to a fourth embodiment of the present invention. The construction of the HDD according to this embodiment is basically equal to that according to the above-described second embodiment, shown in FIG. 4, except, for example, the employment of the magnetic disk according to the above-described third embodiment. Therefore, the description thereof will mainly be given of only the difference from the first embodiment, while the description of the corresponding parts will be omitted for brevity.

In the HDD according to this embodiment, since the rigidity of the magnetic disk 13 is made to become continuously higher as the position on the disk 13 separates from the spindle shaft, the waves at the outer circumferential portion of the disk 13 during the rotation thereof is reducible and the rigidity thereof varies continuously over the entire area and, hence, the occurrence of singular points or unnecessary wave modes is suppressible. It is preferable that the rate of continuous variation is determined in view of the system, the head configuration, particularly the vibration characteristics of the ABS surface and the suspension 16, and other factors. Thus, since the rigidity of the magnetic disk 13 is made to become continuously higher as the position on the disk 13 separates from the spindle shaft, the magnetic head 17 can take a stable flying height and can float stably with respect to all the tracks.

Because of the enhancement of the rigidity of the ribs 8 through the chemical treatment, even if the height of the ribs 8 is as low as 0.08 mm, the magnetic disk 13 showed stable rotation. Moreover, when the speed of rotation was increased up to 70S⁻¹ (4,200 rpm), waves hardly occurred and a desirable result was produced. This result shows that the further reduction in thickness of the disk substrate is feasible. Still moreover, according to this embodiment, since the magnetic disk 13 and the spindle motor 14 share the shaft 2, the need for a damper is eliminable, which contributes to thickness/weight reduction, cost reduction and increase in recording density.

As described above, the HDD according to this embodiment can minimize the waves which occur in conjunction with the rotation of a magnetic disk, thereby decreasing the head flying height to realize high-density recording. That is, in comparison with a disk with the same thickness, the value of waves of the disk according to this embodiment is substantially equal thereto even if it undergoes rotation at a higher speed, which achieves the reduction of the head flying height. In other words, this can reduce accordingly the thickness of the disk substrate for the equivalent recording density, which contributes greatly to the thickness reduction of the entire apparatus.

In addition, each of the ribs 8 is made such that its width is expanded toward an outer circumference of the magnetic disk 13, which prevents the thickness of the entire disk 13 from increasing at the outer circumferential portion thereof. Furthermore, the interferential or positional relation with respect to other parts at the rotation of the disk 13 can be set equally irrespective of the position in a radial direction, which facilitates the design distribution.

Still additionally, in the ribs 8, a concentration of the potassium ions to be substituted for a portion of the sodium ions of the rib glass becomes higher toward the outer circumference of the disk 13. This enables the rigidity gradient of the ribs 8 to be changed without changing the dimension of the ribs 3, which allows the optimization of the rigidity.

The above-mentioned replacement condition with potassium ions, the height and shape of the ribs 8, and others are not limited to this embodiment, but proper changes are possible.

(Fifth Embodiment)

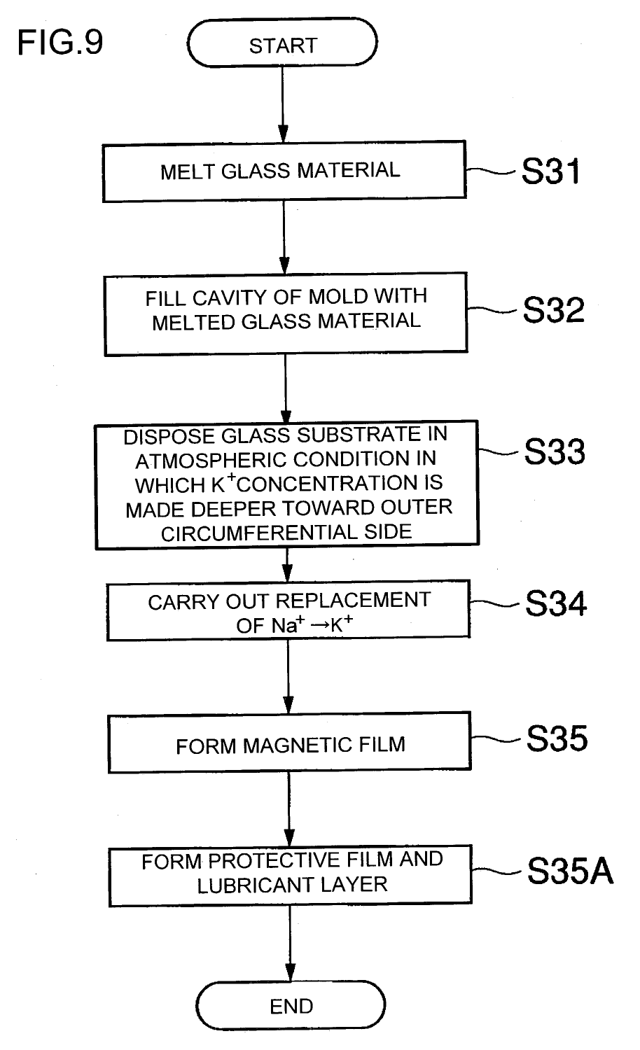

Referring to FIGS. 8 to 9, a description will be given hereinbelow of a magnetic disk according to a fifth embodiment of the present invention. The appearance, or the entire construction, of this magnetic disk is basically the same as that of the magnetic disk according to the first embodiment shown in FIG. 1. FIG. 8 is an illustration of the relationship between a position on a magnetic disk in a radial direction and a potassium ion replacement (substitution) depth, that is, a range in which sodium ions contained in a surface of the magnetic disk are replaced with potassium ions, according to the fifth embodiment of the present invention, and FIG. 9 is a flow chart showing a method of manufacturing a magnetic disk according to the fifth embodiment of the present invention.

In this embodiment, as well as the above-described first embodiment, as glass reinforcing method, there is employed a chemically treating method which can avoid the occurrence of distortion. Concretely, sodium ions of a silicate glass substrate are replaced with potassium ions each having a radius larger than that of the sodium ions and belonging to the same IA group in the periodic table. The replacement depth is approximately several tens to 150 μm from the surface. That is, at the outermost circumferential portion of the magnetic disk, potassium ion replacement is made with respect to the overall thickness of the silicate glass substrate. The replacement depth can properly be determined to required characteristics of the disk.

As FIG. 8 shows, the potassium ion replacement is made such that the replacement depth becomes greater as the position on the disk in a radial direction approaches an outer circumferential portion of the disk. This can further increase the glass strength toward the outer circumferential portion of the disk. That is, the rigidity of the disk is continuously enhanced toward the outer circumferential portion thereof.

It is known that the waves or run-out of a disk are evaluated on the basis of the acceleration in a direction perpendicular to a rotation direction, which is generally called ACC (ACCeleration). Also in this embodiment, the chemical reinforcement of the disk utilizes the fact that the radius of an sodium ion is approximately 0.1 nm while the radius of a potassium ion is approximately 0.13 nm larger than that of the sodium ion. This difference in radius therebetween produces a compressive stress on a surface of the glass, thereby enhancing the strength of the glass. Moreover, in this embodiment, for example, the potassium ion replacement depth is set to be in proportion to approximately the fourth power of the radius. In this case, in a test, a satisfactory result was produced in the reduction of the ACC (acceleration conversion) on the run-out of the disk. The power to be raised with respect to the radius can properly selectively be determined while measuring the ACC.

Thus, the waves incidental to the rotation of the disk are reducible. Accordingly, on the recording density or flying height condition permitting equivalent waves, the thickness reduction of the glass substrate becomes feasible. That is, the weight reduction and the thickness reduction are achievable. Moreover, in other words, if the disks have the same thickness, a further reduction of the flying height becomes feasible and a further reduction of the space loss becomes possible, which signifies that the recording density is improvable.

In addition, also in this embodiment, a shaft 2 is formed integrally with the disk substrate 1 as shown in FIG. 1. Therefore, according to the present invention, since the shaft 2 integrated with the disk functions as the shaft itself of the spindle motor, the occurrence of the RRO due to the alignment error between a hub and the inner-diameter portion of the disk when the disk is mounted in the apparatus is reducible, which enables a servo pattern to be easily and satisfactorily written even in the case of a high-density track pitch. Moreover, the need for a damper is eliminable, which contributes to the thickness reduction and the cost reduction.

Referring to a flow chart of FIG. 9, a description will be given hereinbelow of a method of manufacturing a magnetic disk according to this embodiment.

For carrying out the procedure shown in FIG. 9, a glass material, which has previously undergone preparation/adjustment treatment, is placed into a cullet condition.

In FIG. 9, first, a step (melting process) S31 is implemented to melt the glass material placed into the cullet condition. The heating temperature therefor is properly set at a temperature higher than the softening point, taking viscosity into consideration. Preferably, the condition thereof is determined taking into consideration the molding time, the molding characteristics, the capability of the molding machine, and other factors.

Following this, a step (filling process) S32 is implemented to putting the melted glass material in a mold with a cavity having a required configuration. Preferably, as the material (SiC, ZrO₂, or the like) of the mold, and for the surface treatment, the coating and others, appropriate materials (TiC, TiN, or the like) are used taking the glass used into consideration. In this embodiment, the shaft 2 is molded at the same time.

Subsequently, the molded body gradually cooled and removed from the mold, i.e., a disk substrate, is chemically reinforced. At this time, steps (replacement process) S33 and S34 are implemented to replace the sodium ions of the disk substrate with potassium ions so that the potassium ion replacement depth becomes greater toward an outer circumferential portion of the disk substrate. Concretely, the disk substrate is immersed in a potassium nitrate solution, and is pressurized to promote the reaction speed toward the outer circumference of the disk or exposed to temperatures which become higher toward the outer circumference thereof. The molar concentration and others are set taking the temperature, the time and others into consideration. Another method is also acceptable, provided that the potassium ion replacement is made deeper toward the outer circumferential side thereof.

Thereafter, the cleaning treatment and others are carried out with respect to the glass substrate, and a step (film build-up process) S35 is conducted where a Co—Cr-based magnetic thin film is formed thereon by means of the sputtering technique, and a step (film formation process) S35A is conducted where a DLC serving as a protective film and a lubricant layer are further formed thereon, thus completing a magnetic disk. The film build-up is conducted by appropriately selecting the degree of vacuum, the Ar gas density, the condition on the target, the under-layer or seed layer for the formation of the magnetic layer, and others, thereby providing a disk with satisfactory magnetic characteristics.

(Sixth Embodiment)

A description will be given hereinbelow of a magnetic disk apparatus (HDD) according to a fourth embodiment of the present invention. The construction of the HDD according to this embodiment is basically equal to that according to the above-described second embodiment, shown in FIG. 4, except, for example, the employment of the magnetic disk according to the above-described fifth embodiment. Therefore, the description thereof will mainly be given of only the difference from the first embodiment, while the description of the corresponding parts will be omitted for brevity.

In the HDD according to this embodiment, in the magnetic disk 13, sodium ions contained in a surface of the disk substrate are replaced with potassium ions and a depth of the potassium ion replacement is set such that a depth of the replacement at an outer circumferential portion of the disk substrate is greater than a depth of the replacement at an inner circumferential portion thereof. That is, the rigidity of the magnetic disk 13 is made to become continuously higher as the position on the disk 13 separates from the spindle shaft. Accordingly, the waves at the outer circumferential portion of the disk 13 during the rotation thereof is reducible and the rigidity thereof varies continuously over the entire area and, hence, the occurrence of singular points or unnecessary wave modes is suppressible. It is preferable that the rate of continuous variation is determined in view of the system, the head configuration, particularly the vibration characteristics of the ABS surface and the suspension 16, and other factors. Thus, since the rigidity of the magnetic disk 13 is made to become continuously higher as the position on the disk 13 separates from the spindle shaft, the magnetic head 17 can take a stable flying height and can float stably with respect to all the tracks. Because of the enhancement of the rigidity of the magnetic disk 13, when the speed of rotation was increased up to 4000S⁻¹ (4,000 rpm), waves hardly occurred and a desirable result was produced. This result shows that the further reduction in thickness of the disk substrate is feasible. Thus, the thickness/weight reduction and density enhancement of the HDD are feasible irrespective of the cost reduction.

(Seventh Embodiment)

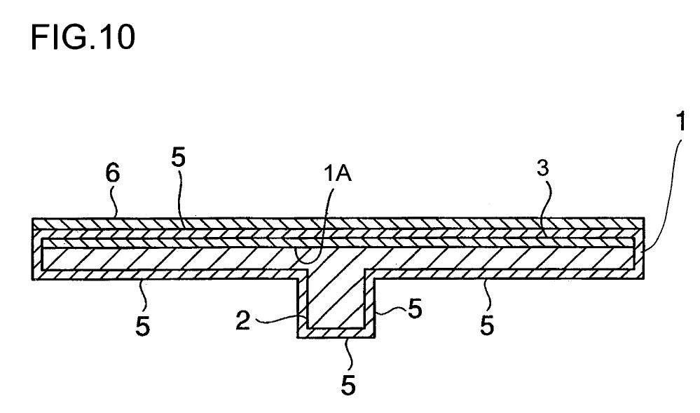

Referring to FIGS. 1 and 10, a description will be given hereinbelow of a magnetic disk according to a seventh embodiment of the present invention. FIG. 10 is a cross-sectional view showing the magnetic disk according to this embodiment.

In FIGS. 1 and 10, a magnetic disk has a flat member (disk substrate) 1 composed of a silicate glass substrate having a diameter of approximately 20 mm (0.8 inch) and a thickness of approximately 0.3 mm, with a surface thereof being reinforced chemically or mechanically. In addition, the flat member 1 has a shaft 2 made of the same material and integrally provided at a central portion on a surface of the flat member 1 opposite to a main surface 1A holding a magnetic recording layer 3, with the shaft 2 being formed to have a diameter of approximately 4 mm and a length of 0.8 mm (see the above-described first embodiment). The main surface 1A is a flat surface having almost no irregularities, and a magnetic recording layer 3, such as Co—Cr-based material, is build up thereon by means of sputtering. A protective film 5 is then formed on the magnetic recording layer 4 through the use of a DLC (Diamond Like Carbon) employing carbon as a principal component, and a lubricant layer 6 using a fluorine-based material or the like is further formed thereon. The structure of the magnetic recording layer 3 depends properly upon the surface recording density of a disk to be used or the head flying height. In this embodiment, the fly height signifying the flying height is set at approximately 15 to 25 nm. The magnetic layer 3, a protective film 5 and a lubricant layer 6 are set at approximately 13 nm, 5 nm and 2 nm in thickness, respectively. Moreover, the surface recording density is set at 30 Gbpsi (Giga Bits Per Square Inch).

For the disk substrate 1, a glass material, which has previously undergone preparation/adjustment treatment, is placed into a cullet condition, and is heated to be melted for the molding at a viscosity higher than that softening point and further put in a mold and pressurized, thus form a structure in which the shaft 2 is integrated with the main surface 1A. As shown in FIG. 10, the protective film 5 located on the magnetic recording layer 3 is not only provided over the entire main surface 1A of the disk but also provided over the rear side of the main surface 1A after extending through end surfaces of the disk, and even provided on the entire surface of the shaft 2 so that the protective film 5 having an electrical conductive property exists continuously between the shaft 2 and the main surface 1A. As the material (SiC, ZrO₂, or the like) of the mold, and for the surface treatment, the coating and others, appropriate materials are selected taking into consideration the glass material to be used, the molding temperature, the life, and others.

In this magnetic disk, the protective film having an electrical conductive property and lying between the shaft 2 and the main surface 1A establishes almost the same electric potential over the entire disk to prevent the static electricity electrification even in a conventional situation without taking special measures against the static electricity. This prevents the quality of the magnetic disk from degrading due to the discharge of the static electricity or the like. In addition, owing to the employment of the amorphous DLC, even if the magnetic disk collides against the magnetic head, a high hardness of the DLC minimizes the damages to the recording magnetic layer 3, which contributes to a reliability of the magnetic disk. In other words, the reduction of damages occurring in a magnetic disk producing process or in a process of transfer of a master pattern to a magnetic disk through magnetic transfer or the like becomes feasible, which not only enhances the yield in the processes but also improves the workability and even contributes to the cost reduction.

Moreover, conventional manufacturing processes are available without changing, which eliminates the costly equipment investment. In this embodiment, although the magnetic recording layer 3 and the lubricant layer 6 are made to extend between end portions of the main surface 1A of the disk, the present invention is not limited to this, but proper modification is also acceptable. The DLC film can be formed by sputtering as well as the magnetic recording layer 3, which eliminates the need for the equipment investment.

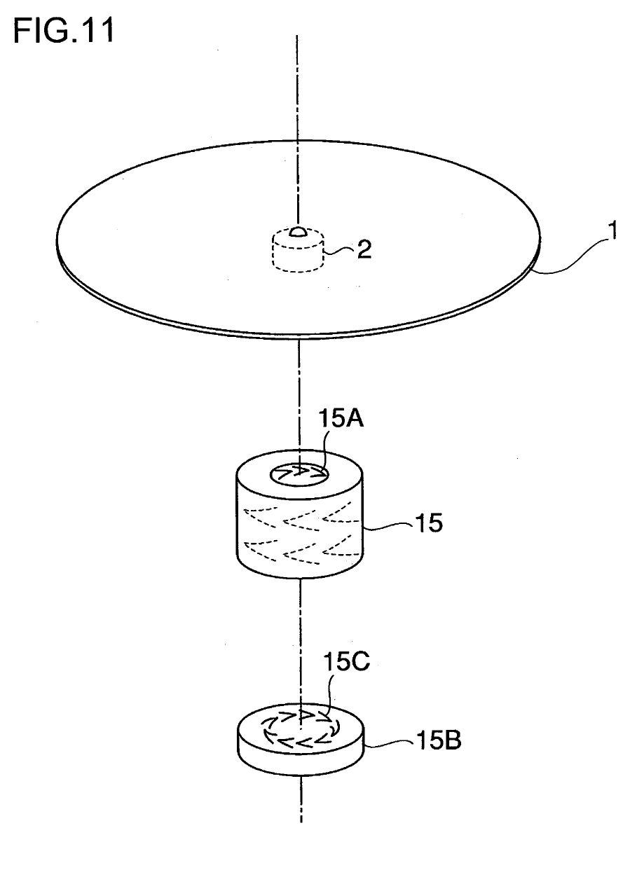

Furthermore, referring to FIG. 11, a description will be given hereinbelow of the relationship between the magnetic disk and a bearing. In FIG. 11, the shaft 2 of the magnetic disk is designed such that its outer circumferetial surface is supported by a radial fluid dynamic bearing 15 and its end surface is supported by a thrust fluid dynamic bearing 15B. In an inner surface of the radial fluid dynamic bearing 15, dynamic pressure grooves 15A are made to generate a dynamic pressure according to the rotation of the shaft 2. In this embodiment, the grooves are formed into a herringbone configuration. Likewise, in the thrust fluid dynamic bearing 15B, dynamic pressure grooves 15C are made to produce a dynamic pressure in conjunction with the rotation of the shaft 2.

These dynamic pressure grooves are made by means of rolling. The groove configuration, the number of grooves, the spacing therebetween and others can properly be altered so as to provide a characteristic for a required rotational accuracy. Moreover, in this embodiment, the fluid dynamic bearings 15 and 15B are made of brass. It is also appropriate that they are made of stainless. Although a detailed explanation about the fluid dynamic bearings will be omitted, they are designed such that a fluid is led to dynamic pressure grooves by its viscosity in accordance with the rotation of the shaft 2 to generate a pressure in a vertical direction with respect to a plane for supporting the shaft 2 because the dynamic pressure grooves are formed into a cul-de-sac condition. The employment of the fluid dynamic bearing contributes to the improvement of the rotational accuracy of the shaft 2 and the noise reduction.

In addition, preferably, an oil to be used for the fluid dynamic bearing 15 is of a type which has a good viscosity temperature coefficient characteristic and a chemically stable property and a less saturated vapor pressure. In this embodiment, a fluorine-based oil is used as a base oil and a required additive is added thereto to improve its characteristic, and for providing a necessary electrical conductive property, a proper quantity of carbon having a uniform particle size and having a high dispersibility is further added thereto to come into a colloid state. It is considered that carbon behaves just like an extreme pressure agent to prevent the abrasion stemming from the contact with a metal and, hence, a better life characteristic is obtainable.

(Eighth Embodiment)

A description will be given hereinbelow of a magnetic disk apparatus (HDD) according to an eighth embodiment of the present invention. The construction of the HDD according to this embodiment is basically equal to that according to the above-described second embodiment, shown in FIG. 4, except, for example, the employment of the magnetic disk according to the above-described seventh embodiment. Therefore, the description thereof will mainly be given of only the difference from the first embodiment, while the description of the corresponding parts will be omitted for brevity.

A ramp 21 is provided at a retreating position of an actuator comprising a suspension 16 and a coil arm 19, and the actuator is unloaded and held at the retreating position in cooperation with a tub 22 set at the tip portion of the suspension 16, when the actuator is in a non-activated condition. At the retreating position, the magnetic head 17 is placed so as not to overlap with the magnetic disk in a face-to-face condition, that is, a plane of the magnetic head 17 is positioned so as not to overlap with a plane of the magnetic disk. In this embodiment, at the retreating position, the magnetic head 17 is located to be separated by approximately 1 mm from a circumferential end surface of the magnetic disk.

Furthermore, in the HDD according to this embodiment, a direct insulation resistance between magnetic recording layer 3 and the magnetic head 17 during the operation is set to be higher than an indirect electric resistance developing through a circuit substrate, i.e., an electric circuit section. In response to the rotation of the magnetic disk, a relative motion occurs between the disk and the ambient air, and accompanying this, a surface of the disk is electrified with static electricity. Still furthermore, the fluid dynamic bearing 15 falls into a non-contact condition with the shaft 2 and, hence, usually the static electricity is hard to discharge. For this reason, the static electricity is discharged through an air membrane between the magnetic disk and the magnetic head 17. This exerts influence on a GMR film to lead to a drop of an MR rate signifying a rate of change of magnetic resistance, which can deteriorates a reproduced signal and, in a worse case, it can damage the magnetic head 17.

According to this embodiment, since the direct insulation resistance between the magnetic recording layer 3 and the magnetic head 17 is set to be higher than the indirect electric resistance developing through the circuit substrate, i.e., the electric circuit section, the static electricity can be discharged through the circuit substrate having a less resistance, it is possible to prevent the influence on the magnetic head 17. Moreover, since the fluid of the fluid dynamic bearing 15 has an electrical conductive property, it is possible to more securely preventing the effect on the magnetic head 17. Still moreover, since the magnetic head 17 is retreated into a position where it does not overlap with the magnetic disk in a face-to-face condition when being in a non-operating condition, even if the magnetic disk is electrified due to vibrations from the external while the magnetic disk apparatus is in a non-activated condition, the insulation resistance between the magnetic head 17 and the magnetic disk can be maintained at a sufficiently high value to prevent the static electricity from being directly discharged from the magnetic disk to the magnetic head 17, thus contributing to the enhancement of the reliability thereof. Yet moreover, in this embodiment, since the magnetic head 17 is made to be loaded after the magnetic disk reaches a steady-state rotation, when the magnetic head is retreated into the ramp 21, the distance between the magnetic head 17 and the magnetic disk is lengthened, thereby reducing the electrostatic capacity. Therefore, assuming that the electrification has occurred, if the quantity of electricity is constant, the electrification voltage increases to facilitate the discharge of the static electricity, but the electrification elimination is possible, thus maintaining a high reliability.

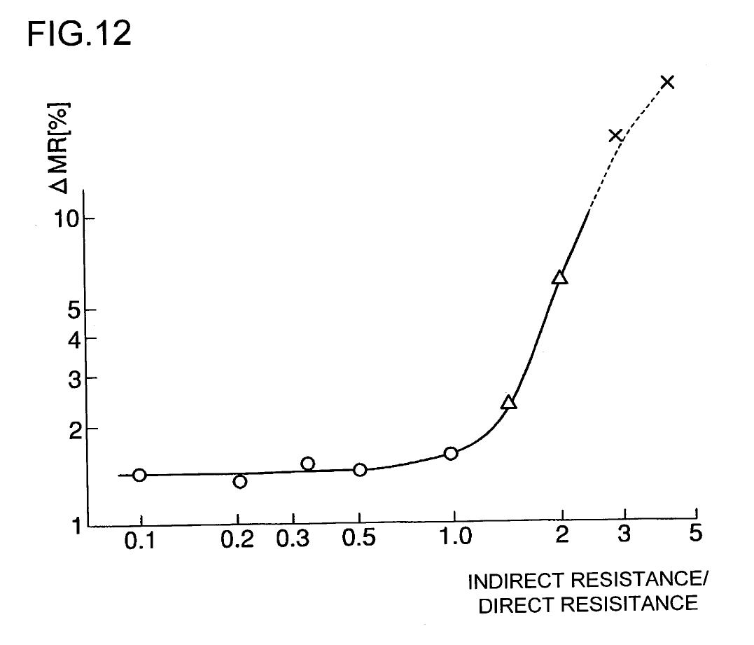

Referring to FIG. 12, a description will be given hereinbelow of a concrete example about this effect. In FIG. 12, the horizontal axis represents a ratio of an indirect electric resistance value (Indirect R) in the case of the passage from the magnetic recording layer 3 through the circuit substrate and a direct insulation resistance value (Direct R) in the case of the passage from the magnetic recording layer 3 to the magnetic head 17, while the vertical axis denotes a rate of variation (ΔMR) of a rate of change of magnetic resistance (MR rate) in a case in which static electricity is discharged after the electrification. Although a detailed description about test conditions is omitted, the MR rate of the magnetic head 17 was measured in a state where the relative humidity was sufficiently lowered and the readout was made by the magnetic head 17 for a constant period of time under an easily-electrified condition. In the illustration, the “circle” marks signify almost no variation of the MR rate, the “triangle” marks represent slight variation thereof, and the “cross” marks depict no output generation due to damages to the GMR film. As seen from this illustration, the “circle” marks signifying no variation appear in a case in which the ratio (Indirect R/Direct R) on the horizontal axis is below approximately 1, that is, in a case in which the direct insulation resistance between the magnetic recording layer 3 and the magnetic head 17 is set to be higher than the indirect electric resistance developing through the circuit substrate, i.e., the electric circuit section as mentioned above. This means that the discharge of the static electricity was made through a path having a less resistance, and signifies that the construction according to this embodiment provides a magnetic recording apparatus with higher reliability.

Considering a server, very-small-sized portable equipment and other apparatus requiring further enhancement of recording density and a higher transfer rate based on higher-speed rotation, it is expected that a magnetic head to be used is shifted from GMR to TMR and CPP which are more sensitive to static electricity and a fluid dynamic bearing becomes essential. The magnetic disk apparatus according to this embodiment can cope sufficiently with these tendencies and can improve the reliability.

In addition, since the shaft 2 is put into common use between the magnetic disk and the spindle motor 14, the need for the employment of a clamper is eliminable, which enables the thickness/weight reduction, the cost reduction, and the recording density enhancement.

It should be understood that the present invention is not limited to the above-described embodiments, and that it is intended to cover all changes and modifications of the embodiments of the invention herein which do not constitute departures from the spirit and scope of the invention.

What is claimed is:

1. A magnetic disk using a glass as a disk substrate and chemically reinforced so that its rigidity becomes higher toward an outer circumference thereof.

2. The magnetic disk according to according to claim 1, wherein said glass is a silicate glass containing sodium ions, and the sodium ions in a surface of said disk substrate are replaced with potassium ions so that a replacement potassium ion concentration becomes higher as a position on said surface of said disk substrate approaches the outer circumference.

3. The magnetic disk according to according to claim 1, wherein a shaft is formed integrally at a central portion of said magnetic disk, and a magnetic recording layer is formed on a main surface of said magnetic disk perpendicular to said shaft.

4. A magnetic disk manufacturing method comprising:
a first step of melting a glass for a substrate of a magnetic disk;
a second step of putting the melted glass in a cavity of a mold for formation of a shaft to produce a disk substrate; and
a third step of placing said disk substrate in a predetermined atmospheric condition to reinforce said disk substrate so that its rigidity becomes higher toward an outer circumference of said disk substrate.

5. The magnetic disk manufacturing method according to claim 4, wherein, in said first step, a silicate glass containing sodium ions is used as said glass, and in said third step, a portion of said sodium ions is replaced with potassium ions so that a concentration of the replacement ions becomes higher as a position on said surface of said disk substrate approaches the outer circumference.

6. The magnetic disk manufacturing method according to claim 4, wherein, in said third step, said predetermined atmospheric condition is made such that said disk substrate is immersed in a potassium nitrate solution and is exposed to temperatures which becomes higher toward the outer circumference of said disk substrate to adjust a reaction speed thereof.

7. A magnetic disk manufacturing method comprising:
a step of melting a glass containing sodium ions;
a step of putting the melted glass in a mold for producing a disk glass substrate; and
a step of placing said disk glass substrate, removed from said mold, in an atmospheric condition that a concentration of potassium ions increases toward an outer circumference of said disk glass substrate for replacing a portion of said sodium ions of said disk glass substrate with said potassium ions so that a rigidity of said disk glass substrate increases toward an outer circumference of said disk substrate.

8. A magnetic disk apparatus comprising:
a magnetic disk using a glass as a disk substrate;
a motor for rotating said magnetic disk;
a magnetic head for recording/reproducing data on/from said magnetic disk; and
a voice coil motor for shifting said magnetic head to a given track,
wherein said disk substrate is chemically reinforced so that its rigidity increases toward its outer circumference.

9. A magnetic disk comprising:
a disk substrate made from a silicate glass;
a magnetic recording layer provided on one main surface of said disk substrate; and
rib means which is provided on the other main surface of said disk substrate and whose rigidity becomes higher as a position on said disk substrate approaches its outer circumference.

10. The magnetic disk according to claim 9, wherein the width of said rib means is made to be successively greater toward the outer circumference thereof.

11. The magnetic disk according to claim 9, wherein said rib is made from a silicate glass, and a portion of sodium ions of said silicate glass is replaced with potassium ions so that a concentration of the replacement potassium ions becomes higher toward the outer circumference thereof.

12. A magnetic disk apparatus comprising:
a magnetic disk in which a silicate glass is used as a disk substrate and a magnetic recording layer is provided on its one main surface;
a motor for rotating said magnetic disk;
a magnetic head for carrying out recording/reproduction of data on/from said magnetic disk; and
a voice coil motor for shifting said magnetic head to a required track,
wherein, in said magnetic disk, rib means whose rigidity becomes higher toward an outer circumference of said disk substrate is provided on the other main surface of said disk substrate.

13. The magnetic disk apparatus according to claim 12, wherein a shaft is formed integrally with said disk substrate at a central portion of said magnetic disk.

14. A magnetic disk using a silicate glass as a disk substrate, wherein sodium ions contained in a surface portion of said disk substrate are replaced with potassium ions up to predetermined depths in said surface portion of said disk substrate so that a depth of the replacement of the sodium ions with the potassium ions from a surface of said disk substrate at an outer circumferential portion of said disk substrate is greater than a depth of the replacement of the sodium ions with the potassium ions therefrom at an inner circumferential portion thereof.

15. The magnetic disk according to claim 14, wherein the replacement depth is set to be successively greater toward the outer circumferential portion of said disk substrate.

16. The magnetic disk according to claim 15, wherein said disk has a shaft formed integrally with said disk substrate to be positioned at its central portion, with a magnetic recording layer being placed on a main surface of said disk substrate perpendicular to said shaft.

17. A magnetic disk manufacturing method comprising:
a step of melting a silicate glass containing sodium ions;
a step of putting the melted silicate glass in a cavity of a mold for producing a disk glass substrate; and
a step of replacing a portion of the sodium ions of said silicate glass with potassium ions for chemically reinforcing said disk glass substrate,
wherein a depth of the replacement from a surface of said disk glass substrate, which forms a replacement range in which the sodium ions are replaced with the potassium ions, is set to be continuously greater toward an outer circumferential portion of said disk glass substrate.

18. A magnetic disk apparatus comprising:
a magnetic disk using a glass as a disk substrate and having a shaft integrated with said disk substrate;
a motor for rotating said magnetic disk;
a magnetic head for carrying out recording/reproduction on/from said magnetic disk; and
a voice coil motor for shifting said magnetic head to a required track,
wherein, in said magnetic disk, sodium ions contained in a surface portion of said disk substrate are replaced with potassium ions up to predetermined depths in said surface portion of said disk substrate so that a depth of the replacement of the sodium ions with the potassium ions from a surface of said disk substrate at an outer circumferential portion of said disk substrate is greater than a depth of the replacement of the sodium ions with the potassium ions therefrom at an inner circumferential portion thereof to continuously enhance a rigidity of said disk substrate in a direction departing from said shaft.

19. A magnetic disk comprising:
a flat member made of a glass forming a non-magnetic and electrical insulating material;
a magnetic recording layer provided on one surface of said flat member;
a shaft made of a glass forming a non-magnetic and electrically insulating material and formed integrally at a central portion of said flat member on a surface of said flat member opposite to said magnetic recording layer provided surface thereof; and
a protective film having an electrical conductive property and placed over said magnetic recording layer, said flat member and said shaft in the continuous form from said magnetic recording layer to said shaft.

20. The magnetic disk according to claim 19, wherein an amorphous carbon material having an electrical conductive property is used as a principal component of said protective film.

21. A magnetic disk apparatus comprising:
a magnetic disk including:
a flat member made of a glass forming a non-magnetic and electrical insulating material;
a magnetic recording layer provided on one surface of said flat member;
a shaft made of a glass forming a non-magnetic and electrically insulating material and formed integrally at a central portion of said flat member on a surface of said flat member opposite to the magnetic recording layer provided surface thereof; and
a protective film having an electrical conductive property and placed over said magnetic recording layer, said flat member and said shaft in the continuous form from said magnetic recording layer to said shaft;
a fluid dynamic bearing for rotatably supporting said shaft of said magnetic disk;
a magnetic head disposed in the vicinity of said magnetic recording layer of said magnetic disk; and
a circuit connected to said magnetic head for carrying out recording/reproduction of a signal on/from said magnetic disk,
wherein a direct insulation resistance between said magnetic recording layer and said magnetic head is set to be higher than an indirect electric resistance developing through said circuit.

22. The magnetic disk apparatus according to claim 21, wherein a magneto-resistive element is used, for said magnetic head.

23. The magnetic disk apparatus according to claim 21, wherein an oil having an electrical conductive property is used for said fluid dynamic bearing.

24. The magnetic disk apparatus according to claim 21, wherein, when said magnetic disk apparatus is in a non-operating condition, said magnetic head is retreated into a position where its surface does not overlap with said magnetic disk in a face-to-face condition.
